(19) United States
(12) Patent Application Publication
(10) Pub. No.: US 2024/0363934 A1
(43) Pub. Date: Oct. 31, 2024

(54) TOP COVER INJECTION MOLDING STRUCTURE OF POWER BATTERY

(71) Applicant: NINGBO ZHENYU TECHNOLOGY CO., LTD., Ningbo (CN)

(72) Inventor: Shiya He, Ningbo (CN)

(21) Appl. No.: 18/308,815

(22) Filed: Apr. 28, 2023

(51) Int. Cl. H01M 50/15; H01M 50/184; H01M 50/188; H01M 50/342; H01M 50/55; H01M 50/627

(52) U.S. Cl. CPC H01M 50/15; H01M 50/184; H01M 50/188; H01M 50/3425; H01M 50/55; H01M 50/627

(57) ABSTRACT

The disclosure relates to the field of lithium batteries, and specifically relates to a top cover injection molding structure of a power battery. The top cover injection molding structure comprises a top cover sheet and a terminal assembly. The top cover sheet is provided with a terminal hole for the terminal assembly to fit. A plurality of connecting bosses are provided on a periphery of the terminal hole. The terminal assembly comprises a first plastic piece, a terminal and a seal. After the terminal is assembled to the terminal hole by the seal, a first plastic piece is obtained by injection molding on a periphery of the terminal.

### TECHNICAL FIELD

The disclosure relates to the field of lithium batteries, and specifically relates to a top cover injection molding structure of a power battery.

### BACKGROUND

Power battery is an important component of new energy vehicles. The existing new energy vehicles mostly use lithium-ion batteries as power batteries. For power lithium batteries, in addition to key components such as battery cells and BMS, battery case structure is also an important safety factor. Among them, terminal is an integral part of a battery module. In addition to being connected to a positive electrode and a negative electrode of a battery cell in the module for electrical conductivity, the terminal also needs to have corresponding structural strength and sealing requirements to meet the requirements of new energy vehicles.

However, the existing battery top cover has complex structure and high manufacturing cost, which limits the large-scale application of the lithium batteries.

### SUMMARY

The object of the disclosure is to provide a top cover injection molding structure of a power battery with firm structure and lower large-scale manufacturing cost.

In order to achieve the above object, the disclosure adopts the following scheme:
A top cover injection molding structure of a power battery, comprises:

a top cover sheet which is provided with a terminal hole in a penetrating manner, where a plurality of connecting bosses are convexly provided around a periphery of the terminal hole, and a first concave-convex piece is formed on the connecting boss; and
a terminal assembly which is fitted to the top cover sheet to form a positive terminal or a negative terminal; where the terminal assembly comprises a first plastic piece, a terminal and a seal, the terminal is assembled to the terminal hole, the seal is arranged between the terminal and the top cover sheet, and the first plastic piece is obtained by injection molding on the periphery of the terminal; a boss cavity is molded in the first plastic piece for accommodating the connecting bosses, a second concave-convex piece is molded in the boss cavity, and the first plastic piece is connected to the top cover sheet through concave-convex fit between the first concave-convex piece and the second concave-convex piece, so that the terminal and the seal are fixed to the top cover sheet by the first plastic piece;
and the terminal is insulated from the top cover sheet by the first plastic piece and the seal.

In one embodiment of the present application, during an injection molding and cooling process of the first plastic piece, a predetermined pressure is applied to the terminal so that the seal is in a compressed state, and after the injection molding and cooling and removal of the pressure, the seal is kept in the compressed state by connection of the first plastic piece.

In one embodiment of the present application, the first plastic piece is in the shape of a flat circular ring and comprises a plastic ring body and a plastic ring inner hole located in the middle of the plastic ring body, and the plastic ring inner hole is used for fitting at least a part of the terminal therein.

In one embodiment of the present application, the boss cavity is formed on a bottom surface of the plastic ring body.

In one embodiment of the present application, an upper terminal, a terminal fixing portion and a lower terminal are sequentially formed on the terminal, the upper terminal and the lower terminal are respectively arranged protruding upwards and downwards relative to the terminal fixing portion, and the terminal fixing portion is arranged protruding relative to the upper terminal and the lower terminal in a lateral direction.

In one embodiment of the present application, a gap is formed between the terminal fixing portion and the connecting boss, and the gap is filled by the first plastic piece during the injection molding for insulation.

In one embodiment of the present application, a fourth concave-convex piece is provided on a circumference of the terminal fixing portion or the upper terminal, a third concave-convex piece is correspondingly molded on the first plastic piece, and the fourth concave-convex piece and the third concave-convex piece are in concave-convex fit with each other to lock a circumferential rotation of the terminal.

In one embodiment of the present application, the fourth concave-convex piece and the third concave-convex piece are a notch and a bump respectively, and a plurality of notches and bumps are arranged along a circumferential direction.

In one embodiment of the present application, the plastic ring body is arranged to wrap side walls of the upper terminal and the terminal fixing portion, so that a cavity portion is formed in the plastic ring body, so that only a top surface of the terminal is exposed after the injection molding.

In one embodiment of the present application, a sunken platform is formed at an area where the connecting boss is arranged, and the sunken platform is filled by the first plastic piece after the injection molding; a convex platform is also provided around the terminal hole, and a concave ring is arranged on a periphery of the convex platform, the concave ring is in the shape of a circular ring and is recessed relative to the sunken platform, so that the seal is positioned on the convex platform and the concave ring.

In one embodiment of the present application, a second plastic piece made of an insulating material is arranged under the top cover sheet, a first connecting piece is provided on a bottom surface of the top cover sheet, and a second connecting piece is correspondingly provided on the second plastic piece, and the second connecting piece and the first connecting piece are snapped together or in connection fit after heat fusion, so that the second plastic piece is fixedly connected to an underside of the top cover sheet.

In one embodiment of the present application, the top cover sheet is further provided with an explosion-proof valve or an electrolyte injection port.

In one embodiment of the present application, the explosion-proof valve is a split-type explosion-proof valve and comprises an explosion-proof valve plate and an explosion-proof valve film, the top cover sheet is provided with an explosion-proof valve hole in a penetrating manner, the explosion-proof valve plate is welded to an underside of the explosion-proof valve hole, and the explosion-proof valve film is attached to an upside of the explosion-proof valve hole.

In one embodiment of the present application, the explosion-proof valve is an integral explosion-proof valve and comprises an explosion-proof valve plate integrally molded on the top cover sheet and an explosion-proof valve film attached to the explosion-proof valve plate.

In one embodiment of the present application, the positive terminal and the negative terminal are arranged on a same top cover sheet to form an integral power battery top cover assembly.

In one embodiment of the present application, the positive terminal and the negative terminal are respectively arranged on different top cover sheets to form a split-type power battery top cover assembly.

In one embodiment of the present application, the connecting boss is formed by stamping on the top cover sheet, the connecting boss is a columnar structure, a molding hole is formed under the connecting boss, and the first concave-convex piece in the shape of a hat is molded on a top thereof.

In one embodiment of the present application, the connecting bosses are evenly distributed along a circular ring concentric with the terminal hole.

In one embodiment of the present application, a terminal mounting hole is formed around the terminal hole.

The top cover injection molding structure of the disclosure has the following beneficial effects:
1. The production process is simplified, the number of parts is small, and the assembly can be automated, which reduces operators by 50%, increases output by 30%, and reduces overall costs by more than 35% compared to existing production lines.
2. The connecting boss used for connection and fixation during the injection molding of the first plastic piece can be obtained by processing during the molding of the top cover sheet, without increasing complexity of the manufacturing process.
3. The first plastic piece is pulled between the first plastic piece and the top cover sheet through mutual concave-convex fit between the first concave-convex piece with a hat shape on the top and the second concave-convex piece formed in the first plastic piece during the injection molding, avoiding scrapping of finished products caused by the laser welding process.
4. In some embodiments of the present application, the first plastic piece wraps all the connecting bosses therein, and the torsional performance of the terminal is also improved through the concavo-convex structure between the first plastic piece and the terminal.
5. The predetermined pressure can be applied to the terminal during the injection molding process of the first plastic piece and kept until the first plastic piece is completely cooled and shaped, thus meeting the airtightness requirement of the terminal.

### BRIEF DESCRIPTION OF THE DRAWINGS

FIG. 1 is a schematic structural view of a top cover injection molding structure of a power battery according to a certain embodiment of the disclosure;

FIG. 2 is a structural exploded view of the embodiment of FIG. 1;

FIG. 3 is a sectional exploded view of the embodiment of FIG. 1;

FIG. 4 is a top view of a top cover sheet in the embodiment of FIG. 1;

FIG. 5 is a bottom view of FIG. 4;

FIG. 6 is a bottom structural view of a first plastic piece in the embodiment of FIG. 1;

FIG. 7 is a sectional structural view of a positive terminal in the embodiment of FIG. 1; and

FIG. 8 is a schematic structural view of a terminal in the embodiment of FIG. 1.

### REFERENCE NUMERALS IN THE DRAWINGS

top cover sheet 10, terminal assembly 20, explosion-proof valve 30, second plastic piece 40, positive terminal 201, negative terminal 202,
terminal mounting hole 11, connecting boss 12, terminal hole 13, electrolyte injection port 14, convex platform 15, concave ring 16, sunken platform 17, molding hole 18, first connecting piece 19,
first plastic piece 21, terminal 22, seal 23,
explosion-proof valve hole 31, explosion-proof valve plate 32, explosion-proof valve film 33, second connecting piece 41,
first concave-convex piece 121,
plastic ring body 211, plastic ring inner hole 212, boss cavity 213, second concave-convex piece 214, third concave-convex piece 215, cavity portion 216,
upper terminal 221, terminal fixing portion 222, lower terminal 223, and fourth concave-convex piece 224.

### DESCRIPTION OF THE EMBODIMENTS

In order to enable those skilled in the art to better understand the disclosure and thereby define the scope of the disclosure more clearly, the disclosure is described below in detail with respect to some specific embodiments of the disclosure. It should be noted that the following description only describes some specific embodiments of the inventive concept and are only part of the embodiments of the disclosure, specific and direct descriptions of relevant structures are merely for the convenience of understanding the disclosure, and the specific features do not, of course, directly limit the implementation scope of the disclosure. Conventional choices and alternatives made by those skilled in the art under the guidance of the inventive concept should be considered within the scope of the disclosure.

A top cover assembly for a power battery is made by an injection molding process. The top cover assembly comprises a top cover injection molding structure to fix a terminal assembly 20 to a top cover sheet 10 to form a positive terminal 201 or a negative terminal 202.

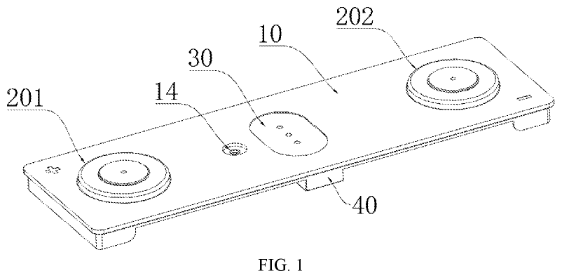

For example, as shown in FIG. 1, a positive terminal 201 and a negative terminal 202 are formed at intervals on one top cover sheet 10, thereby forming an integral power battery top cover assembly. Of course, in other embodiments, when the positive terminal 201 and the negative terminal 202 are respectively arranged on one top cover sheet 10, a split-type power battery top cover assembly can also be formed.

In the integral power battery top cover assembly shown in FIG. 1, an explosion-proof valve 30 and an electrolyte injection port 14 are also provided between the positive terminal 201 and the negative terminal 202, where the explosion-proof valve 30 is used to burst open for pressure release when the internal pressure of the battery is too high to ensure safety of the battery, and the electrolyte injection port 14 is used to fill the battery with an electrolyte after the battery is assembled. In the present embodiment, the explosion-proof valve 30 and the electrolyte injection port 14 are known in the art and are not limited in the present application.

Referring to FIG. 1, a second plastic piece 40 made of an insulating material is also provided under the top cover sheet 10, and insulation and material strength thereof meet insulation and connection requirements of the power battery. The second plastic piece is also known in the art and is not limited in the present application.

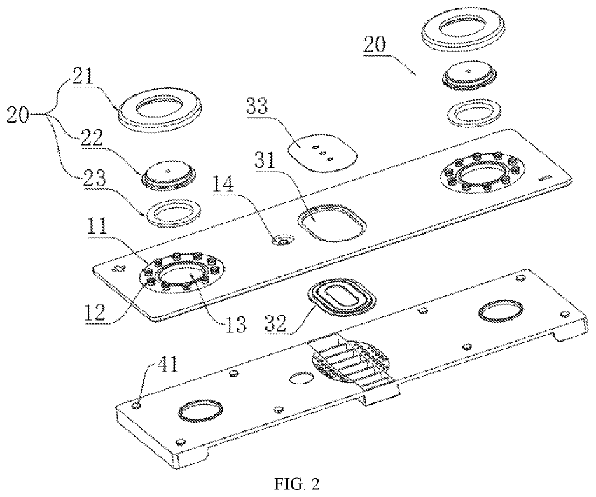

Referring to FIG. 2, the top cover sheet 10 is provided with a terminal hole 13 in a penetrating manner, and a terminal mounting hole 11 is formed around the terminal hole 13 for mounting a terminal 22. In the present embodiment, a seal 23 is provided between the terminal 22 and the top cover sheet 10 to insulate and seal the terminal and the seal. As shown in the figure, the seal 23 is a sealing ring made of a material with insulation and compression elasticity meeting the usage requirements.

Referring to FIG. 2, a plurality of connecting bosses 12 are convexly provided on the top cover sheet 10 around a periphery of the terminal hole 13. Preferably, the connecting bosses 12 are evenly distributed along a circular ring concentric with the terminal hole 13. The connecting bosses 12 may be formed integrally with the top cover sheet 10 during the molding process of the top cover sheet, or may be obtained through corresponding steps in the manufacturing process of the top cover sheet 10. Preferably, the top cover sheet 10 is made of an alloy material with good shaping properties, such as aluminum alloy, so that the connecting bosses 12 can be formed through a bottom-up stamping operation during the molding process of the top cover sheet 10, and a first concave-convex piece 121 is further molded on the connecting boss 12 for connecting the first plastic piece 21 to the top cover sheet.

For example, in some embodiments, the connecting boss 12 with the first concave-convex piece 121 is manufactured in two steps. In the first step, the top cover sheet 10 is stamped from bottom to top to form a convex platform with a cylindrical shape, and a bottom of the convex platform is hollow to form a molding hole 18; and in the second step, the molded convex platform is stamped from top to bottom to shape a top thereof sideways to form the first concave-convex piece 121 in the shape of a hat.

Of course, the above-mentioned shape of the first concave-convex piece 121 is exemplary and not limited thereto.

The first plastic piece 21 is obtained by injection molding on the top cover sheet 10 while maintaining a pressure on the terminal 22, so that the seal 23 is in a compressed state after the first plastic piece 21 is cooled and shaped. Moreover, the terminal 22 is insulated from the top cover sheet 10 by the first plastic piece 21 or the seal 23. The degree of compression of the seal 23 can be set according to needs, without any limitation.

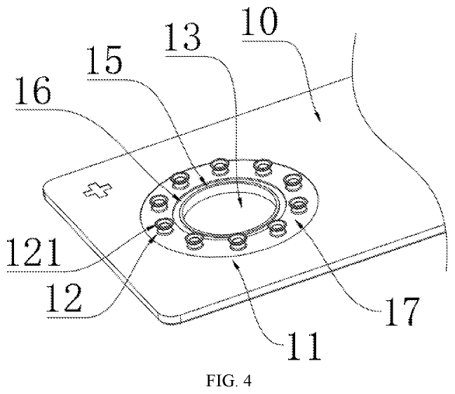

As shown in FIG. 4, in the present embodiment, a sunken platform 17 is formed on the top cover sheet 10 at an area where the connecting boss 12 is arranged, and the sunken platform is arranged sunken relative to other areas of the top cover sheet 10. The sunken platform 17 is filled by the first plastic piece 21 after the injection molding, so that the terminal assembly 20 and the top cover sheet 10 form an integral structure. In addition, a convex platform 15 and a concave ring 16 arranged on a periphery of the convex platform 15 are provided around the terminal hole 13, where the concave ring 16 is in the shape of a circular ring and is recessed relative to the sunken platform 17.

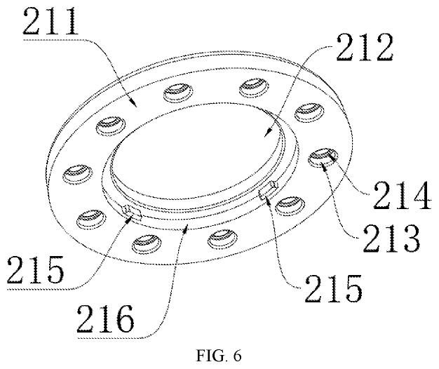

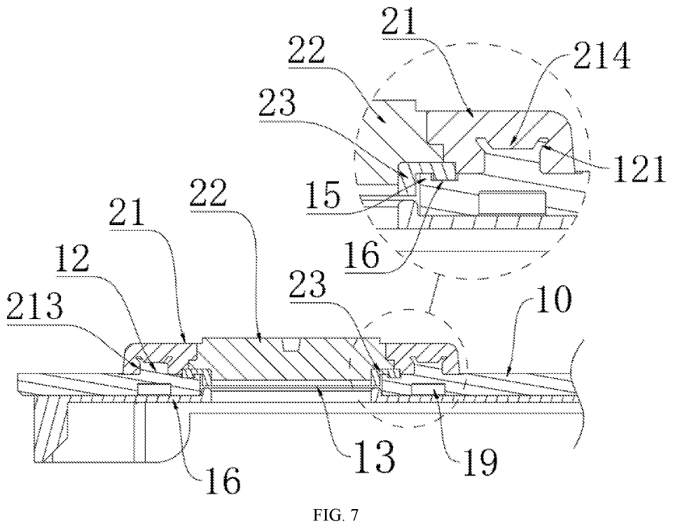

Referring to FIGS. 6 and 7, in the present embodiment, the first plastic piece 21 is generally in the shape of a relatively flat circular ring. The first plastic piece 21 comprises a plastic ring body 211 and a plastic ring inner hole 212 located in the middle of the plastic ring body 211. The plastic ring body 211 is obtained by the injection molding around the terminal 22, and the plastic ring inner hole 212 is used for at least part of the terminal 22 to fit therein.

A boss cavity 213 is formed on a bottom surface of the plastic ring body 211 for accommodating the connecting boss 12, and is also obtained during the injection molding, and the boss cavity 213 is also provided with a second concave-convex piece 214, the second concave-convex piece 214 is in fit with the first concave-convex piece 121 of the connecting boss 12 to form a concave-convex connection relationship, thereby connecting the first plastic piece 21 to the connecting boss 12, even though the first plastic piece 21 is fixed to the top cover sheet 10.

As mentioned above, during the injection molding and cooling process of the first plastic piece 21, a certain pressure is applied to the terminal 22 so that the seal 23 is in a compressed state, and after the injection molding and cooling and removal of the pressure, the seal 23 is substantially kept in the compressed state under the action of the first plastic piece 21. Moreover, the terminal 22 is insulated from the top cover sheet 10 or the connecting boss 12 by the first plastic piece 21 or the seal 23, so that the top cover sheet 10 is not electrically connected with the terminal 22.

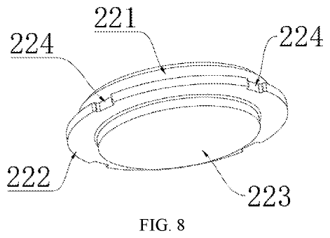

Referring to FIG. 8, the terminal 22 is formed from top to bottom into an upper terminal 221, a terminal fixture 222 and a lower terminal 223, where the upper terminal 221 and the lower terminal 223 are respectively arranged protruding upwards and downwards relative to the terminal fixing portion 222, and the terminal fixing portion 222 is arranged protruding relative to the upper terminal 221 and the lower terminal 223 in a lateral direction.

Therefore, after the terminal 22 is assembled to the terminal hole 13, a lower surface of the terminal fixing portion 222 is in contact with an upper surface of the seal 23, and the lower terminal 223 at least partially extends into the terminal hole 13 and is insulated by the seal 23. Moreover, a gap is formed between the terminal fixing portion 222 and the connecting boss 12, and the gap is filled by the first plastic piece 21 during the injection molding for insulation.

In order to improve torsion resistance of the terminal 22 after the injection molding, a fourth concave-convex piece 224 is provided on the terminal fixing portion 222 or the upper terminal 221. During the injection molding, a third concave-convex piece 215 in concave-convex fit with the fourth concave-convex piece 224 can be molded on the first plastic piece 21, so that a circumferential rotation of the terminal 22 can be locked, thus improving torsional resistance of the terminal 22.

In the present embodiment, the fourth concave-convex piece 224 is a notch recessed on a side wall of the terminal fixing portion 222. Correspondingly, the third concave-convex piece 215 is a bump formed during the injection molding and located on the plastic ring body 211, the notch is in fit with the bump to lock the rotation of the terminal 22, so that a rotation limiting structure is provided in addition to the injection molding viscosity of the first plastic piece 21 and the terminal 22.

In the present embodiment, the plastic ring body 211 is arranged to wrap side walls of the upper terminal 221 and the terminal fixing portion 222 of the terminal 22, so that a cavity portion 216 is formed in the plastic ring body 211, so that only a top surface of the terminal 22 is exposed after the injection molding.

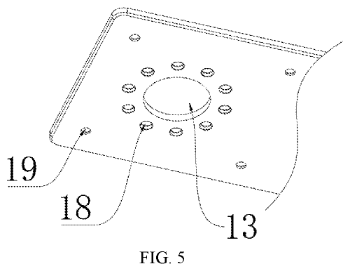

As shown in FIG. 5, a first connecting piece 19 is molded on a bottom surface of the top cover sheet 10 for connecting the second plastic piece 40, and correspondingly, a second connecting piece 41 is formed on the second plastic piece 40. The first connecting piece 19 and the second connecting piece 41 are in a concave-convex fit structure, so that the second plastic piece 40 can be snap-connected to an underside of the top cover sheet 10, or the second connecting piece 41 is fitted and shaped in the first connecting piece 19 after heat fusion to form a concave-convex connection structure.

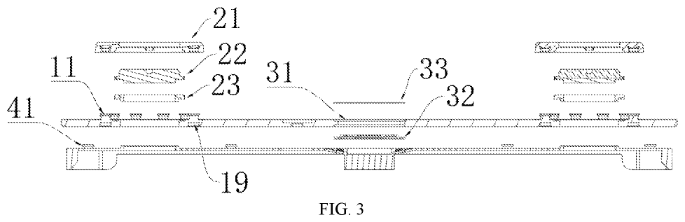

Referring to FIGS. 2 and 3, the explosion-proof valve 30 is a split-type explosion-proof valve, the top cover sheet 10 is provided with an explosion-proof valve hole 31 in a penetrating manner, an explosion-proof valve plate 32 is welded to an explosion-proof valve hole 31 from bottom to top, and an explosion-proof valve film 33 is attached to an upside of the explosion-proof valve hole 31. Of course, in other embodiments, an integral explosion-proof valve instead of the split-type explosion-proof valve may be integrally molded on the top cover sheet 10 during the molding process thereof, that is, the explosion-proof valve 30 is formed by integrally molding the explosion-proof valve plate 32 on the top cover sheet 10 and attaching the explosion-proof valve film 33 to the explosion-proof cover plate.

What is claimed is:

1. A top cover injection molding structure of a power battery, comprising:
a top cover sheet which is provided with a terminal hole in a penetrating manner, wherein a plurality of connecting bosses are convexly provided around a periphery of the terminal hole, and a first concave-convex piece is formed on the connecting boss; and
a terminal assembly which is fitted to the top cover sheet to form a positive terminal or a negative terminal; wherein the terminal assembly comprises a first plastic piece, a terminal and a seal, the terminal is assembled to the terminal hole, the seal is arranged between the terminal and the top cover sheet, and the first plastic piece is obtained by injection molding on the periphery of the terminal; a boss cavity is molded in the first plastic piece for accommodating the connecting bosses, a second concave-convex piece is molded in the boss cavity, and the first plastic piece is connected to the top cover sheet through concave-convex fit between the first concave-convex piece and the second concave-convex piece, so that the terminal and the seal are fixed to the top cover sheet by the first plastic piece;
wherein the terminal is insulated from the top cover sheet by the first plastic piece and the seal.

2. The top cover injection molding structure of a power battery according to claim 1, wherein during an injection molding and cooling process of the first plastic piece, a predetermined pressure is applied to the terminal so that the seal is in a compressed state, and after the injection molding and cooling and removal of the pressure, the seal is kept in the compressed state by connection of the first plastic piece.

3. The top cover injection molding structure of a power battery according to claim 2, wherein the first plastic piece is in the shape of a flat circular ring and comprises a plastic ring body and a plastic ring inner hole located in the middle of the plastic ring body, and the plastic ring inner hole is used for fitting at least a part of the terminal therein; and the boss cavity is formed on a bottom surface of the plastic ring body.

4. The top cover injection molding structure of a power battery according to claim 3, wherein an upper terminal, a terminal fixing portion and a lower terminal are sequentially formed on the terminal, the upper terminal and the lower terminal are respectively arranged protruding upwards and downwards relative to the terminal fixing portion, and the terminal fixing portion is arranged protruding relative to the upper terminal and the lower terminal in a lateral direction; and a gap is formed between the terminal fixing portion and the connecting boss, and the gap is filled by the first plastic piece during the injection molding for insulation.

5. The top cover injection molding structure of a power battery according to claim 4, wherein a fourth concave-convex piece is provided on a circumference of the terminal fixing portion or the upper terminal, a third concave-convex piece is correspondingly molded on the first plastic piece, and the fourth concave-convex piece and the third concave-convex piece are in concave-convex fit with each other to lock a circumferential rotation of the terminal.

6. The top cover injection molding structure of a power battery according to claim 5, wherein the fourth concave-convex piece and the third concave-convex piece are a notch and a bump respectively, and a plurality of notches and bumps are arranged along a circumferential direction.

7. The top cover injection molding structure of a power battery according to claim 4, wherein the plastic ring body is arranged to wrap side walls of the upper terminal and the terminal fixing portion, so that a cavity portion is formed in the plastic ring body, so that only a top surface of the terminal is exposed after the injection molding; and
a sunken platform is formed at an area where the connecting boss is arranged, and the sunken platform is filled by the first plastic piece after the injection molding; a convex platform is also provided around the terminal hole, and a concave ring is arranged on a periphery of the convex platform, the concave ring is in the shape of a circular ring and is recessed relative to the sunken platform, so that the seal is positioned on the convex platform and the concave ring.

8. The top cover injection molding structure of a power battery according to claim 1, wherein a second plastic piece made of an insulating material is arranged under the top cover sheet, a first connecting piece is provided on a bottom surface of the top cover sheet, and a second connecting piece is correspondingly provided on the second plastic piece, and the second connecting piece and the first connecting piece are snapped together or in connection fit after heat fusion, so that the second plastic piece is fixedly connected to an underside of the top cover sheet.

9. The top cover injection molding structure of a power battery according to claim 1, wherein the top cover sheet is further provided with an explosion-proof valve or an electrolyte injection port;
the explosion-proof valve is a split-type explosion-proof valve and comprises an explosion-proof valve plate and an explosion-proof valve film, the top cover sheet is provided with an explosion-proof valve hole in a penetrating manner, the explosion-proof valve plate is welded to an underside of the explosion-proof valve hole, and the explosion-proof valve film is attached to an upside of the explosion-proof valve hole; or the explosion-proof valve is an integral explosion-proof valve and comprises an explosion-proof valve plate integrally molded on the top cover sheet and an explosion-proof valve film attached to the explosion-proof valve plate.

10. The top cover injection molding structure of a power battery according to claim 9, wherein the positive terminal and the negative terminal are arranged on a same top cover sheet to form an integral power battery top cover assembly, or the positive terminal and the negative terminal are respectively arranged on different top cover sheets to form a split-type power battery top cover assembly;
the connecting boss is formed by stamping on the top cover sheet, the connecting boss is a columnar structure, a molding hole is formed under the connecting boss, and the first concave-convex piece in the shape of a hat is molded on a top thereof;
the connecting bosses are evenly distributed along a circular ring concentric with the terminal hole; and
a terminal mounting hole is formed around the terminal hole.
